(19) United States
(12) Patent Application Publication
(10) Pub. No.: US 2002/0132037 A1
(43) Pub. Date: Sep. 19, 2002

(54) Herbal sweetener composition

(76) Inventor: James H. Zhou, Wallingford, CT (US)

Correspondence Address: George A. Coury, Bachman & LaPointe, P.C., Suite 1201, 900 Chapel Street, New Haven, CT, 06510-2802, US

(21) Appl. No.: 10/091,191

(22) Filed: Mar. 5, 2002

Related U.S. Application Data
(63) Continuation of application No. 09/102,402, filed on Jun. 22, 1998, now abandoned.

(51) Int. Cl. A23G 3/00

(52) U.S. Cl. 426/658

(57) ABSTRACT

An herbal sweetener composition includes a naturally occurring sugar selected from the group consisting of glucose, fructose, maltose and mixtures thereof and a terpene glycoside. The composition is ideal for individuals concerned about elevated blood sugar levels and the like, and a method is also provided.

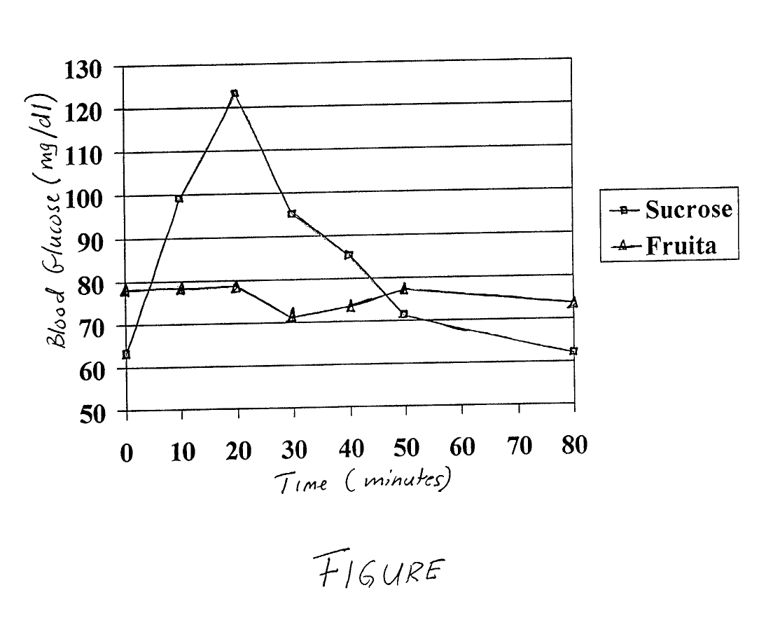

### BACKGROUND OF THE INVENTION

The invention relates to an herbal composition and, more particularly, to an herbal sweetener composition which is low in calories and ideal for use as a substitute for refined sugar or sucrose.

A major health concern for Americans today is reducing calories in their diet while enjoying all natural and great tasting foods and beverages.

Refined sugar (sucrose) elevates the blood glucose levels in the human body, a condition which can be dangerous to certain individuals suffering from conditions such as glycemia and the like. In addition, sucrose has a relatively high content of calories and can be undesirable from a dieting standpoint.

A large number of proposals have been made for providing a substitute sweetener to take the place of sucrose. Despite numerous efforts, however, the need remains for an all natural and low calorie sweetener which does not possess the high levels of calories as possessed by sucrose, and which does not tend to elevate blood glucose in the human body.

It is therefore a primary object of the present invention to provide a sweetener composition which does not elevate blood glucose in the human body.

It is a further object of the present invention to provide a sweetener composition which provides comparable sweetness to sucrose with reduced caloric content.

It is a still further object of the present invention to provide a sweetener composition which is formulated from natural ingredients.

Other objects and advantages will appear hereinbelow.

### SUMMARY OF THE INVENTION

In accordance with the present invention, the foregoing objects and advantages have been readily attained.

According to the invention, an herbal sweetener composition is provided with comprises a naturally occurring sugar selected from the group consisting of glucose, fructose, maltose and mixtures thereof and a terpene glycoside.

In further accordance with the present invention, a method is provided for sweetening food products for individuals concerned about blood sugar level, which method comprises the steps of providing an herbal sweetener comprising a naturally occurring sugar selected from the group consisting of glucose, fructose, maltose and mixtures thereof, and a terpene glycoside; and administering a food product including said herbal sweetener to an individual concerned about blood sugar level, whereby blood glucose levels of said individual remain substantially constant.

### BRIEF DESCRIPTION OF THE DRAWING

A detailed description of illustrative embodiments follows, with reference to the attached figure which comparatively illustrates the blood glucose level over time for sucrose as compared to the Fruita™ sweetener composition of the present invention.

### DETAILED DESCRIPTION OF PREFERRED EMBODIMENT(S)

In accordance with the present invention, an herbal sweetener composition and method are provided whereby, advantageously, a “clean sugar” sweet taste profile can be provided with an approximate 90% reduction in caloric content as compared to sucrose (refined sugar), and further which does not elevate blood glucose in the human body.

In accordance with the present invention, a sweetener composition is provided which is formulated of naturally occurring components. According to the invention, the composition includes a naturally occurring sugar preferably selected from the group consisting of glucose, fructose, maltose and mixtures thereof, as well as a terpene glycoside. In accordance with the present invention, the naturally occurring sugars serve to improve the taste profile of terpene glycosides so as to provide a “clean sugar” sweet taste profile. This advantageously allows the composition of the present invention to be used ideally as a natural ingredient in a broad range of products such as beverages, concentrates, confectionery, medications, dietary supplements, food products and the like.

Still further, and as will be set forth below, the composition of the present invention while providing a “clean sugar” sweet taste profile, does not elevate blood glucose level of the human body, and has a caloric content reduced by approximately 90% as compared to a taste-equivalent amount of sucrose.

The sweetener of the present invention preferably has a composition as follows:

| | |
|---|---|
| naturally occurring | 38-65 |
| carbohydrates (% wt.) | |
| glucose (% wt.) | 10-36 |
| fructose (% wt.) | 15-25 |
| maltose (% wt.) | 5-15 |
| sucrose (% wt.) | 0-2 |
| terpene glycoside (% wt.) | 0.1-10 |
| other carbohydrates (% wt.) | 28-55. |

The naturally occurring sugars and terpene glycoside are preferably present at a ratio of naturally occurring sugar to terpene glycoside by weight of between about 3:1 and about 780:1, more preferably between about 5:1 and about 50:1, more preferably still between about 20:1 and about 30:1, and ideally at about 25:1. At these preferred ratios, the naturally occurring glucose, fructose, and maltose serve advantageously to modify the intense sweet taste profile of the terpene glycoside so as to provide the desired “clean sugar” sweet taste profile.

The composition of the present invention results in a sweetness by weight which is approximately 8 times as sweet as refined sugar. Thus, the sweetener composition of the present invention can be used in greatly reduced doses so as to provide equivalent levels of sweetness as compared to refined sugar.

The terpene glycoside of the present invention is preferably a natural terpene glycoside, and may ideally be terpene glycoside derived or extracted from various edible botanicals or herbs such as, for example, Momordica, Cucurbitaceae, Rubus suavissimus, Stevia rebaudiana, kiwi and mixtures thereof, and specific examples of suitable terpene glycosides include magroside, stevioside, rubusoside and mixtures thereof.

The glucose, fructose and maltose naturally occurring sugars are preferably provided from fruit juice and the like, and the composition of the present invention preferably includes at least about 10% wt. glucose, at least about 15% wt. fructose and at least about 5% wt. maltose.

The sweetener composition of the present invention is an ideal sweetener for use with individuals who are concerned about elevated blood sugar and/or dietary intake of sucrose, one example of which are individuals confined to a hyperglycemic diet. In this field of use, the sweetener composition can readily be added to any type of food, medicine or other nutrient or ingestible product to be given to the individual, and provides a desirably natural clean sugar sweet taste profile without elevating the blood glucose level of the individual. This will be further documented below.

The sweetener composition of the present invention may also include trace amounts of moisture, protein, ash and fat, and the naturally occurring sugars, being all-natural and unrefined ingredients, may from time-to-time include detectable but trace amounts of naturally occurring sucrose. Thus, although ideally 0%, the sweetener composition of the present invention may include up to about 2% wt. of sucrose.

In granular form, the sweetener composition of the present invention has a color which tends to be pale amber to off-white, and is readily provided having a mesh size of between about 15 mesh and about 24 mesh. When properly shipped and stored, the sweetener is stable in finished products for 12 months, and does not break down when heated, for example to temperatures up to at least about 100° C. This makes the sweetener composition an ideal ingredient for all types of food products including those which must be cooked at high temperature. The composition may also be provided in liquid form.

### EXAMPLE

This example illustrates the effect of the sweetener composition of the present invention, referred to herein as Fruita™, as compared to refined sucrose, on the blood glucose level of the human body.

A sweetener composition according to the present invention was prepared having a formula as follows:

Sugars: % (wt) of Total Carbohydrates:

| | |
|---|---|
| glucose | 22% |
| fructose | 20% |
| maltose | 8% |
| sucrose | 0% |
| natural terpene glycosides | 2% |
| other carbohydrates | 48% |

This composition is specifically designed to be 8-10 times sweeter than sucrose. Thus, 1 gram of this composition is equivalent to 8-10 grams of sucrose in respect to the sweetness profile when diluted in 200 ml of water. Human test subjects were administered equivalent dosages in terms of sweetness. Thus, sucrose was administered in 8 gram and 16 gram doses, while the composition of the present invention was administered in 1 gram and 2 gram doses.

The fasting blood glucose level was measured in 11 healthy human testers after ingesting the sucrose or the equivalent amount of the Fruita™ sweetener composition of the present invention.

Twenty minutes after the test subjects consumed sucrose, their blood glucose level rose significantly above the fasting base line as shown by Table 1 set forth below.

TABLE 1

| Timing (minutes) | Sucrose (mg/dl) | Fruita ™ (mg/dl) |
|---|---|---|
| 0 (base line) | 74 | 76 |
| 20 | 118 | 78 |
| Increase above | 44 | 2 |
| base line | | |

The average increase above the fasting base line was 44 mg/dl for sucrose. In comparison, twenty minutes after the test subject consumed the composition of the present invention, the glucose level remained substantially constant, increasing by only 2 mg/dl.

In a separate study using the same composition and individuals, sweetness-equivalent amounts of sucrose and the Fruita™ sweetener composition of the present invention were administered to the test subjects, and blood glucose levels measured from administration or base line at 10, 20, 30, 40, 50 and 80 minutes. The blood glucose levels are set forth below in Table 2, and also illustrated in the attached Figure.

TABLE 2

| Timing (minutes) | Sucrose (mg/dl) | Fruita ™ (mg/dl) |
|---|---|---|
| 0 (base line) | 63 | 78 |
| 10 | 99 | 78 |
| 20 | 123 | 78 |
| 30 | 95 | 71 |
| 40 | 85 | 73 |
| 50 | 71 | 77 |
| 80 | 62 | 73 |

As shown in the Figure and Table 2, while sucrose provided a rapid and relatively large increase in blood glucose level of the test subjects, the sweetener composition of the present invention had substantially no effect on the blood glucose level, which actually dropped a small amount 30 minutes from base line, and then gradually approached the original base line number.

Thus, it should be readily apparent that the sweetener composition of the present invention is a naturally occurring and ideal substitute for sucrose in terms of sweet taste profile, caloric content and effect on blood glucose levels.

This invention may be embodied in other forms or carried out in other ways without departing from the spirit or essential characteristics thereof. The present embodiment is therefore to be considered as in all respects illustrative and not restrictive, the scope of the invention being indicated by the appended claims, and all changes which come within the meaning and range of equivalency are intended to be embraced therein.

What is claimed is:

1. An herbal sweetener composition, comprising:
a naturally occurring sugar selected from the group consisting of glucose, fructose, maltose and mixtures thereof; and
a terpene glycoside.

2. A composition according to claim 1, wherein said naturally occurring sugar and said terpene glycoside are present at a ratio by weight of said naturally occurring sugar to said terpene glycoside of between about 3:1 and about 780:1.

3. A composition according to claim 2, wherein said ratio is between about 5:1 and about 50:1.

4. A composition according to claim 2, wherein said ratio is between about 20:1 and about 30:1.

5. A composition according to claim 2, wherein said ratio is about 25:1.

6. A composition according to claim 1, wherein said composition comprises carbohydrates as follows:

| | |
|---|---|
| naturally occurring | 38-65 |
| carbohydrates (% wt.) | |
| glucose (% wt.) | 10-36 |
| fructose (% wt.) | 15-25 |
| maltose (% wt.) | 5-15 |
| sucrose (% wt.) | 0-2 |
| terpene glycoside (% wt.) | 0.1-10 |
| other carbohydrates (% wt.) | 28-55. |

7. A composition according to claim 1, wherein said terpene glycoside is natural terpene glycoside.

8. A composition according to claim 1, wherein said terpene glycoside is selected from the group consisting of magroside, stevioside, rubusoside, and mixtures thereof.

9. A composition according to claim 1, wherein said terpene glycoside is an extract from natural sources selected from the group consisting of Momordica, Cucurbitaceae, Rubus suavissimus, Stevia rebaudiana, kiwi and mixtures thereof.

10. A composition according to claim 1, wherein said composition is in water soluble granular form.

11. a composition according to claim 1, wherein said composition is in liquid form.

12. A composition according to claim 1 wherein said composition is stable at temperatures up to about 100° C.

13. A composition according to claim 1, wherein said composition is at least about 8 times sweeter than an equivalent amount of refined sugar.

14. A method for sweetening food products for individuals without substantial increase in blood sugar level comprising the steps of:
providing an herbal sweetener comprising a naturally occurring sugar selected from the group consisting of glucose, fructose, maltose and mixtures thereof, and a terpene glycoside; and
administering a food product including said herbal sweetener to an individual, whereby blood glucose levels of said individual remain substantially constant.

15. A method according to claim 14, wherein said naturally occurring sugar and said terpene glycoside are present at a ratio by weight of said naturally occurring sugar to said terpene glycoside of between about 3:1 and about 780:1.

16. A method according to claim 15, wherein said ratio is between about 5:1 and about 50:1.

17. A method according to claim 15, wherein said ratio is between about 20:1 and about 30:1.

18. A method according to claim 15 wherein said ratio is about 25:1.

19. A method according to claim 14, wherein said composition comprises carbohydrates as follows:

| | |
|---|---|
| naturally occurring | 33-65 |
| carbohydrates (% wt.) | |
| glucose (% wt.) | 10-36 |
| fructose (% wt.) | 15-25 |
| maltose (% wt.) | 5-15 |
| sucrose (% wt.) | 0-2 |
| terpene glycoside (% wt.) | 0.1-10 |
| other carbohydrates (% wt.) | 28-55. |

20. A method according to claim 14, wherein said terpene glycoside is natural terpene glycoside.
